(19) United States
(12) Patent Application Publication
(10) Pub. No.: US 2025/0013950 A1
(43) Pub. Date: Jan. 9, 2025

(54) Systems and methods for managing completed jobs associated with a plurality of customers

(71) Applicant: ETAK Systems, LLC, Huntersville, NC (US)

(72) Inventors: Lee Priest, Charlotte, NC (US); Tammie Grogan, Charlotte, NC (US); Adrienne Johnson, Charlotte, NC (US); Alysson Malinoski Mariano, Charlotte, NC (US); Karina Kiyomi Uzumaki, Charlotte, NC (US); Betty Rodriguez, Charlotte, NC (US)

(21) Appl. No.: 18/347,693

(22) Filed: Jul. 6, 2023

(51) Int. Cl. G06Q 10/0631; G06Q 30/04

(52) U.S. Cl. CPC G06Q 10/063114; G06Q 30/04

(57) ABSTRACT

In various embodiments, the present disclosure relates to managing completed jobs associated with a plurality of customers. Steps include training a machine learning model with customer data associated with one or more customers of an infrastructure service provider; parsing data related to one or more jobs, wherein the one or more jobs are associated with the one or more customers of the infrastructure service provider; determining, via the machine learning model, that one or more of the jobs are completed; and performing an action based on the determining.

### FIELD OF THE DISCLOSURE

The present disclosure generally relates to infrastructure and computer systems. More particularly, the present disclosure relates to systems and methods for managing completed jobs associated with a plurality of customers.

### BACKGROUND OF THE DISCLOSURE

Due to the geographic coverage nature of wireless service, there are hundreds of thousands of cell towers in the United States. For example, in 2014, it was estimated that there were more than 310,000 cell towers in the United States. There are various requirements for performing maintenance, audit, and repair work for these towers associated with cellular phone and other wireless communications companies. Infrastructure service providers can receive hundreds or thousands of job requests associated with maintenance, audit, and repair work for infrastructure such as the described cell towers. The present disclosure provides systems and methods for managing customer job requests through job completion. The various embodiments include training and utilizing one or more machine learning models for optimizing and streamlining the jobs from request to completion.

### BRIEF SUMMARY OF THE DISCLOSURE

In an embodiment, systems and methods for managing completed jobs associated with a plurality of customers include training a machine learning model with customer data associated with one or more customers of an infrastructure service provider; parsing data related to one or more jobs, wherein the one or more jobs are associated with the one or more customers of the infrastructure service provider; determining, via the machine learning model, that one or more of the jobs are completed; and performing an action based on the determining.

The steps can further include any of automatically sending an invoice to a customer and notifying an invoicing team. The data can include one or more files, wherein the machine learning model is adapted to identify files related to the completion of a job. The action can include sending an invoice for jobs determined to be completed, wherein the steps further include sending a follow up notification. Sending the follow up notification can be configured to occur at a particular time, wherein the machine learning model is adapted to determine a particular time based on historical payment behaviors of the one or more customers. The steps can further include grouping invoices associated with a specific customer and sending a follow up notification for the group of invoices at a particular time. The training can include any of supervised and unsupervised learning. The customer data can include historical customer data. The steps can further include generating a closeout package for jobs determined to be completed.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a block diagram of a digital device.

FIG. 2 is a flow diagram of the present management system.

FIG. 3 is a flowchart of a process for managing customer infrastructure job requests.

FIG. 4 is a flowchart of a process for managing completed customer infrastructure jobs.

### DETAILED DESCRIPTION OF THE DISCLOSURE

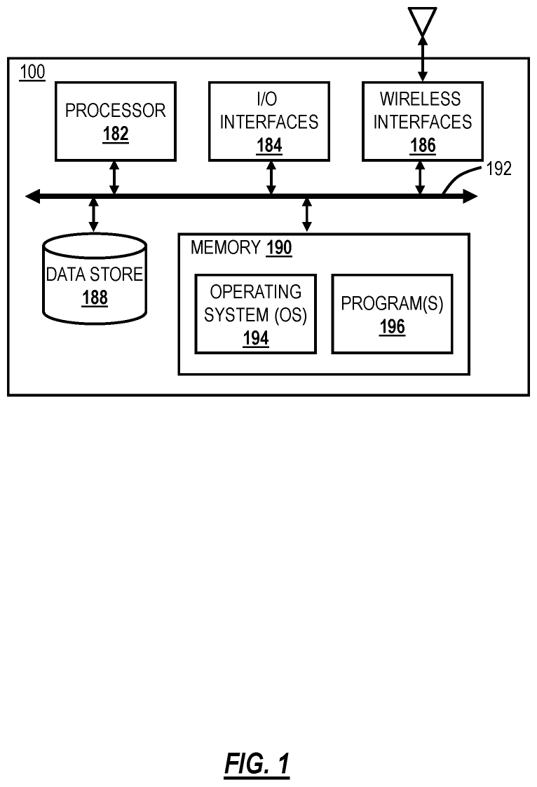

FIG. 1 is a block diagram of a digital device 100 that, in terms of hardware architecture, generally includes a processor 182, input/output (I/O) interfaces 184, wireless interfaces 186, a data store 188, and memory 190. It should be appreciated by those of ordinary skill in the art that FIG. 6 depicts the digital device 100 in an oversimplified manner, and a practical embodiment may include additional components and suitably configured processing logic to support known or conventional operating features that are not described in detail herein. The components (182, 184, 186, 188, and 190) are communicatively coupled via a local interface 192. The local interface 192 can be, for example, but not limited to, one or more buses or other wired or wireless connections, as is known in the art. The local interface 192 can have additional elements, which are omitted for simplicity, such as controllers, buffers (caches), drivers, repeaters, and receivers, among many others, to enable communications. Further, the local interface 192 may include address, control, and/or data connections to enable appropriate communications among the components.

The processor 182 is a hardware device for executing software instructions. The processor 182 can be any custom made or commercially available processor, a central processing unit (CPU), an auxiliary processor among several processors associated with the digital device 100, a semiconductor-based microprocessor (in the form of a microchip or chip set), or generally any device for executing software instructions. When the digital device 100 is in operation, the processor 182 is configured to execute software stored within the memory 190, to communicate data to and from the memory 190, and to generally control operations of the digital device 100 pursuant to the software instructions.

The I/O interfaces 184 can be used to receive user input from and/or for providing system output. The I/O interfaces 184 can also include, for example, a serial port, a parallel port, a small computer system interface (SCSI), an infrared (IR) interface, a radio frequency (RF) interface, a universal serial bus (USB) interface, and the like. The I/O interfaces 184 can include a graphical user interface (GUI) that enables a user to interact with the digital device 100. Additionally, the I/O interfaces 184 may further include an imaging device, i.e. camera, video camera, etc.

The wireless interfaces 186 enable wireless communication to an external access device or network. Any number of suitable wireless data communication protocols, techniques, or methodologies can be supported by the wireless interfaces 186, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 188 may be used to store data. The data store 188 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 188 may incorporate electronic, magnetic, optical, and/or other types of storage media.

The memory 190 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 190 may incorporate electronic, magnetic, optical, and/or other types of storage media. Note that the memory 190 may have a distributed architecture, where various components are situated remotely from one another but can be accessed by the processor 182. The software in memory 190 can include one or more software programs, each of which includes an ordered listing of executable instructions for implementing logical functions. The operating system 194 essentially controls the execution of other computer programs and provides scheduling, input-output control, file and data management, memory management, and communication control and related services. The programs 196 may include various applications, add-ons, etc. configured to provide end user functionality with the digital device 100, including performing various aspects of the systems and methods described herein.

### Cell Site Audits

A cell site audit is used by service providers, third party engineering companies, tower operators, etc. to check and ensure proper installation, maintenance, and operation of the cell site components and shelter or cabinet equipment as well as the various interconnections between them. Sets of cell site components can be sub-divided into sectors, such as into three sectors including an alpha sector, a beta sector, and a gamma sector.

In general, the cell site audit is performed to gather information and identify a state of the cell site. This can be initiated by a job request or scheduled maintenance. This is used to check the installation, maintenance, and/or operation of the cell site. Various aspects of the cell site audit can include, without limitation:

Verify the cell site is built according to a current revision
Verify Equipment Labeling
Verify Coax Cable (“Coax”) Bend Radius
Verify Coax Color Coding/Tagging
Check for Coax External Kinks & Dents
Verify Coax Ground Kits
Verify Coax Hanger/Support
Verify Coax Jumpers
Verify Coax Size
Check for Connector Stress & Distortion
Check for Connector Weatherproofing
Verify Correct Duplexers/Diplexers Installed
Verify Duplexer/Diplexer Mounting
Verify Duplexers/Diplexers Installed Correctly
Verify Fiber Paper
Verify Lacing & Tie Wraps
Check for Loose or Cross-Threaded Coax Connectors
Verify Return (“Ret”) Cables
Verify Ret Connectors
Verify Ret Grounding
Verify Ret Installation
Verify Ret Lightning Protection Unit (LPI)
Check for Shelter/Cabinet Penetrations
Verify Surge Arrestor Installation/Grounding
Verify Site Cleanliness
Verify LTE GPS Antenna Installation

Of note, the cell site audit includes gathering information at and inside one or more shelters, on the cell tower, and at the cell site components. In embodiments, various devices and or technicians can perform any of the tasks for a cell site audit disclosed herein, and in particular to inspect the cell tower, the cell site components, radio center platforms, and the like. In some embodiments, one or more devices, i.e., robots and/or Unmanned Aerial Vehicles (UAVs), can be configured to navigate the cell tower to inspect equipment.

Various methods for performing an audit of a cell site can include utilizing robot systems. These methods can include positioning a robot on a cell tower to perform an audit task chosen from inspecting and monitoring a component of the cell tower or any of the aforementioned tasks. These methods can further include capturing data associated with the component(s) being audited based on the audit task being performed.

Various devices can process the data collected to verify whether the component being audited is in a predetermined condition. The predetermined condition being set based on standard conditions of components required for operation on a cell site. In some embodiments, the data is processed by providing the data for inspection to the engineer/technician. In other embodiments, the data is processed by a robot system performing image comparisons between the data collected and previously categorized data as being in the predetermined condition or not in the predetermined condition.

### Antenna Down Tilt Angle

In an exemplary aspect of the cell site audit, the down tilt angle of individual antennas of the cell site components can be assessed. The down tilt angle can be determined for all of the antennas in all of the sectors. The down tilt angle is the mechanical (external) down tilt of the antennas relative to a support bar, such as radio center platforms. In the cell site audit, the down tilt angle is compared against an expected value, such as from a Radio Frequency (RF) data sheet, and the comparison may check to ensure the mechanical (external) down tilt is within +1.0° of specification on the RF data sheet.

### Antenna Plumb

In an exemplary aspect of the cell site audit and similar to determining the down tilt angle, visually inspecting the antenna including its mounting brackets and associated hardware can be done. This can be done to verify appropriate hardware installation, to verify the hardware is not loose or missing, and to verify that antenna is plumb relative to the support bar.

### Antenna Azimuth

In an exemplary aspect of the cell site audit, verifying the antenna azimuth, such as verifying the antenna azimuth is oriented within ±5° as defined on the RF data sheet can be performed. The azimuth (AZ) angle is the compass bearing, relative to true (geographic) north, of a point on the horizon directly beneath an observed object. The antenna azimuth can be determined using an aerial photo or a GPS measurement device.

### Photo Collections

As part of the cell site audit generally, devices can be used to document various aspects of the cell site by taking photos or video. For example, a device can be used to take photos or video on the ground in or around shelters and can be used to take photos or video up the cell tower and of the cell site components. The photos and video can be stored in a device, a cloud system, and the like.

In an exemplary embodiment, devices can provide real-time video footage back to a controller device or another location (for example, a Network Operations Center (NOC) or the like) from any position on the cell tower.

### Managing Job Requests

Infrastructure service providers, i.e., entities responsible for maintaining, auditing, and installing infrastructure and components associated therewith, can receive many job requests to complete an installation and/or perform an audit task. Such job requests can contain one or more orders from a customer, i.e., an entity associated with the infrastructure for which the job request is made. It will be appreciated that the infrastructure can include, but is not limited to, the cell site and components associated therewith as described herein. Each order, belonging to a single job request or not, must be individually set up in a system. In an embodiment, the present systems and methods provide a management system, including one or more machine learning models, which is adapted and trained to receive and process these job requests through completion, whether they contain a single or multiple orders. These job orders can be received by the management system via a User Interface (UI) associated with the management system or directly retrieved from third party customer systems. That is, a customer can interact directly with the present management system via a UI for providing data and job requests. The management system can be adapted to determine how many orders are received and aggregate them as described herein.

It will be appreciated that the infrastructure service providers described herein can be associated with any infrastructure such as, but not limited to, the cell sites described herein.

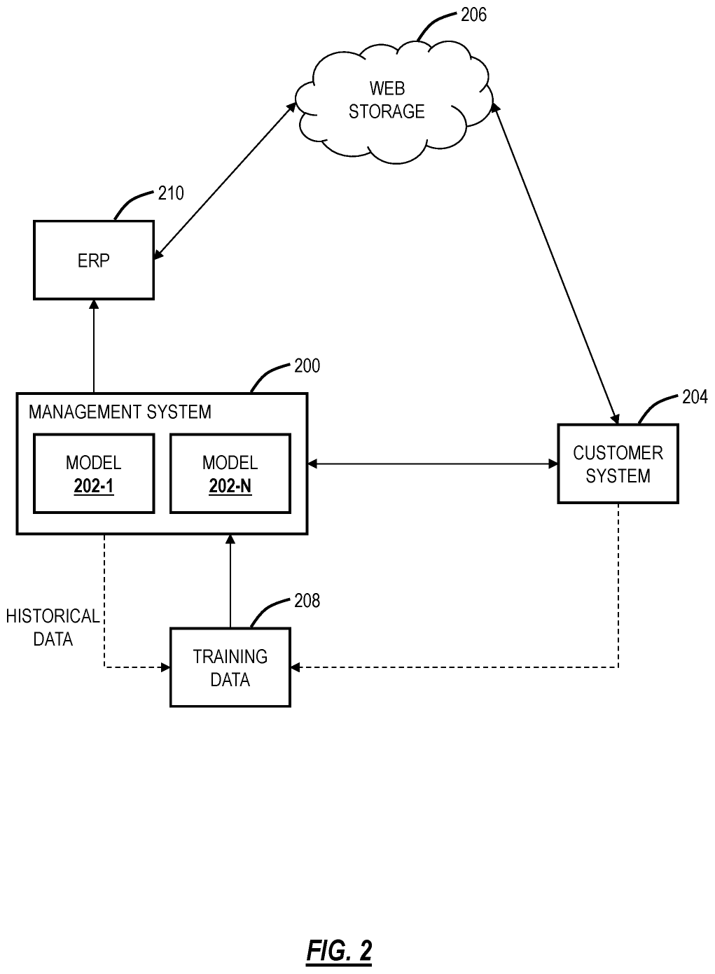

FIG. 2 is a flow diagram of the present management system 200. For singular job requests, analysis must be completed to determine if the request is a new distinct request, or if the request should be concatenated with an existing job request. Once the management system 200 determines the requirements for the job request, depending on the decision, a new job can be opened in an Enterprise Resource Planning (ERP) system 210 associated with the infrastructure service provider. The new job created by the present management system 200 can include a link to a web storage system 206 created and added to the new job in the ERP system 210 by the present management system. This link allows technicians, or anyone associated with the job, to upload data associated with the job. In various embodiments, the link can allow uploading of data which includes photographs, video, documents, files, etc. In various embodiments, the new job can be assigned to a specific region, work group or individual (technicians), etc. by the present management system 200 based on the location of the site or the specific customer which the job is associated with. That is, specific customers may have work groups or individuals which they are required to use to perform the tasks associated with job requests. This assigning can also be based on the training of the one or more machine learning models.

The present management system 200 can further be adapted and trained to handle a plurality of received job requests. This can include a large number of orders with the same scope all received at once i.e., hundreds or thousands of orders/job requests. In these cases, the management system 200 is adapted to review a spreadsheet of the plurality of orders for accuracy. In an embodiment, the management system 200 includes one or more machine learning models (202-1, 202-N). These models can be trained to correct inaccurate data by moving it to another column or field based on the format submitted. The models (202-1, 202-N) can also be trained to replace incorrect or inaccurate data with new data based on reviewing other data submitted that best fits the situation. For example, the management system 200 can be trained to learn which customers are associated with which infrastructure and detect maintenance/audit trends for detecting inaccuracies and replacing data in job requests. Such training can include providing the system historical job requests, i.e., from a training data store 208, and input characteristics associated with various customers. The training data can be collected from customer systems 204 and/or historical job data collected by the present management system 200. The training can include any of supervised and unsupervised learning for the one or more machine learning models.

By training the one or more machine learning models, the management system can ensure that customers are providing required information for the process to continue. For example, the models can be trained to learn what information is necessary based on the type of infrastructure the job request is associated with. That is, by being trained on historical data, and processing the one or more new job requests, the one or more models can determine what information is necessary and automatically fill in any information that may be necessary for the job request to be acceptable. In an exemplary use case, even when a new customer sends a job request, the models can determine what information is necessary based on the information provided, and perform any of automatically filling in missing information, and notifying the customer of what information is additionally required.

In various embodiments, the management system can also be adapted to group a plurality of job requests based on the information provided by the customers. This again can be done in coordination with the one or more machine learning models.

The typical machine learning training process collects data samples, extracts a set of features from these samples, and feeds the features into a machine learning model to determine and recognize patterns related to customer requests. The output of this training process is one or more machine learning models that can remedy customer job request discrepancies/insufficiencies and streamline the process from receiving customer job requests to job completion.

The spreadsheet can then be modified for upload. The new jobs are then opened in the ERP system 210, and the spreadsheet, or other data format, is uploaded to fill in required information for the new jobs. Links to the web storage system 206 are then created and added to each job in the ERP system 210. Templates can also be generated for customers in order to provide customer information. Again, in various embodiments, the new job can be assigned to a specific region, work group or individual, etc. by the present management system.

The present systems and methods can further be adapted to manage Purchase Orders (POs). Infrastructure service providers complete work based on POs provided by customers. In many cases, POs can frequently change, requiring careful management. The management system can be adapted to handle POs and perform various actions based on changes, etc. The management system 200 can be adapted to review an entire system and allow/stop invoicing based on PO receipt from a customer. The management system can learn and be trained on customer systems 204 and thereby can enter POs and PO details into customer systems. Because of this, the management system 200 can also verify PO details in customer systems.

In an embodiment, the present management system 200 can accesses a customer systems 204 (at their request) and create POs on behalf of the customer that are then sent for their approval. Once the management system 200 has access to a customer system 204, it can identify POs that are closed, meaning they cannot be used for billing. Based on this, the management system 200 then begins the process of contacting the customer and having them open a new PO to be used.

In some cases, the PO information in the system can be changed, this requires a re-verification process in which the management system 200 detects a change and electronically contacts the customer(s) and begins reconciliation. The management system 200 might indicate that there is more than one PO for a particular job. Again, the management system 200 can identify multiple POs and subsequently contact and reconcile with the customer.

Another item that can be detected by the management system to trigger reconciliation could be additional lines on the PO that were unexpected, i.e., there might be too many lines, meaning not enough line items with approved spending items. In another case, a PO could be cancelled which is different from a closed PO in that it was outright cancelled. A closed PO can be re-opened, which requires working with the customer to repair. Additionally, the PO might be new, meaning the PO number or identifier has changed. These items can also be detected and reconciled by the present management system 200 as described herein.

### Managing Completed Jobs

Once a job has been completed, further steps are performed by the present management system 200 to facilitate the billing process. The management system 200 can determine a job has been completed by processing uploaded data, i.e., photos, videos, files, etc. and/or receiving a job completed notification from a technician or device. The completion of a job can be detected by the management system 200 by identifying files associated with completion of a job (i.e., a completion form) which are uploaded to the ERP system 210 or web storage 206 by a technician or the like. Additionally, the management system 200 can be adapted to, utilizing the one or more machine learning models, parse uploaded files to identify text or other content in order to determine if a job should be marked as completed. This can reduce the number of stale open jobs which are completed.

Once a job is determined to be completed, the management system 200 notes the job as completed in the ERP system 210. Responsive to noting the job as completed, the management system 200 can then mark the job as unbilled, i.e., identifying the job as officially complete and revenue recognizable from a results perspective, but not yet billed. This ensures that the management system 200 can follow up to make sure the job gets billed in the future. The following up can be configured to occur at predetermined time intervals, or initiated based on other factors such as following up when another job is completed for the same customer. A notification can be sent to a respective party, such as a billing team of the infrastructure service provider, noting the job as billable.

The management system 200 can further be trained to detect payment behaviors of customers and follow up on billing notifications based thereon. For example, the various models (202-1, 202-N) within the management system 200 can be trained on and adapted to learn behaviors of specific customers associated with providing payment. This can be based on historical payment behaviors of customers. That is, certain customers may pay each job as it is completed, whereas other customers may have a specified time, i.e., a time of the month, on which they send payment for outstanding bills. Based on this, the management system 200 can provide follow up notifications based on these insights. For example, the management system 200 can group together completed jobs associated with a customer and provide a follow up billing/invoice notification for the group of completed jobs at a specific time of the month for customers which show such time specific payment habits. This ensures each customer is notified of outstanding bills at an optimal time.

In order for a job to be billable, a closeout package must be provided. The present management system 200 can be adapted to generate closeout packages by consolidating data associated with a job, i.e., photos, data sheets, files, etc., and uploading the closeout package to the ERP system 210 and/or a customers internal system for review. The system can be adapted to mark a job as billable only once a complete closeout package is generated and provided to the customer. Based on approval of the closeout package, by the customer or other managing party, a task is generated telling the management system 200 that the job is now ready to be invoiced. The system can then either send the invoice to the customer and/or an invoicing team of the infrastructure service provider. The management system 200 can follow the same follow up procedure for invoicing as is described above.

In an exemplary embodiment, a closeout package of a site can be performed subsequent to maintenance or installation work. The closeout package method includes, subsequent to the maintenance or installation work, obtaining video capture of site components associated with the work; subsequent to the video capture, processing the video capture to obtain data for the closeout package, wherein the processing comprises identifying the site components associated with the work; and creating a closeout package based on the processed video capture, wherein the close-out package provides verification of the maintenance or installation work and outlines that the maintenance or installation work was performed in a manner consistent with an operator or owner's guidelines. This closeout package can be uploaded to the web storage service 206 for the present management system 200 to process.

In various embodiments of the present disclosure, for identifying jobs as completed and billable, the management system 200 is trained to check for any change orders, scope of work changes, and previously recognized revenue. Each customer can have a unique invoicing procedure as stated below.

In a specific use case, a customer's invoicing procedure can include accessing the customer system, and searching for and locating the PO. The invoice can be edited as needed based on the PO or otherwise left as is. The invoice is then submitted for billing in the customer system, and the management system 200 marks the job/order as invoiced in the ERP system 210. It is noted that customer system, in some cases, can be a third party system which the customer uses to manage their PO and invoicing for vendors. The management system 200 is adapted to access such systems.

In another use case, a customer's invoicing procedure can include submitting a request to invoice in the system or via email to the customer. The customer receives the request to invoice and approves or declines. Based on approval, the management system 200 invoices in the ERP system 210. The management system 200 then uploads the invoice to the customer's system or sends via email or generates a document to mail. The management system 200 then receives a notification on acceptance or rejection from the customer. The management system 200 then marks the order as invoiced in the ERP system 210.

Unbilled orders are orders or jobs that are completed but have not been billed. Various instances are reviewed by the management system 200 and then researched with project managers, customers and any other systems or personnel that can provide information. These instances can include the following. Partial recognition of revenue on an order. This can mean that the order is only partially complete due to access issues, missing equipment, or missing instructions from the customer. Completions are not ready to bill for a variety of reasons. The customer can be holding back some amount before a quality check on the work, for example 10%. The order might be pre-billed, meaning the customer asked to invoice the work before it was completed. The customer may request a hold off on billing, maybe they do not have the budget to pay. Again, these instances are reviewed by the management system 200 in order to determine appropriate action.

A reconciliation of all steps performed by the management system 200 can be provided at specified intervals. For example, at the end of every month, all of the above steps are reconciled to provide a view of results and to keep track of the job process. It will be appreciated that the time interval can also be a year, quarter, week, etc. For generating the reconciliation, the management system 200 can be adapted to reconcile all customer orders worked during this time frame to ensure all numbers match and system identifiers for the orders are correct. The management system 200 can further be adapted to reconcile projects with no revenue, reconcile projects with no cost, and reconcile outliers for performing action thereon, i.e., jobs with numbers that are not in line with historically similar jobs based on the machine learning models (202-1, 202-N) within the present management system 200.

### Process for Managing Job Requests Through Completion

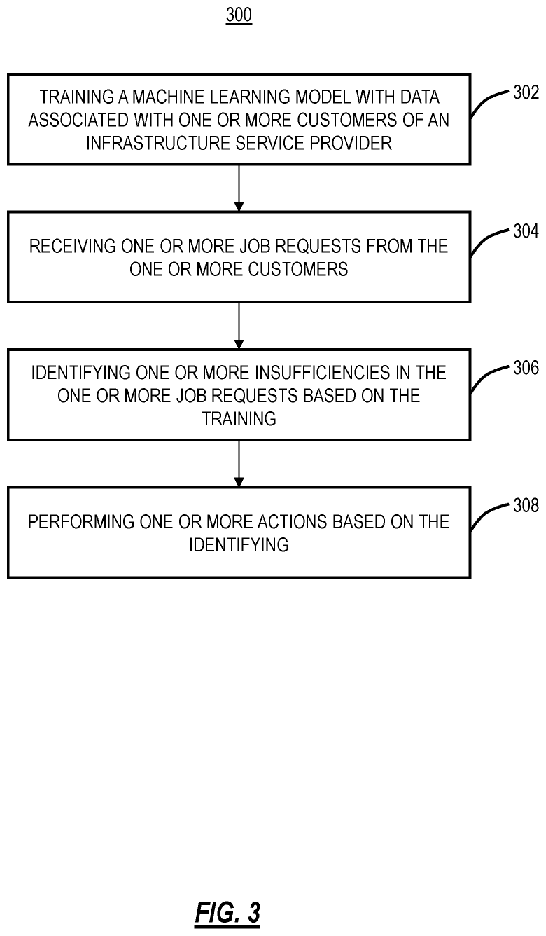

FIG. 3 is a flowchart of a process 300 for managing customer infrastructure job requests. The process 300 includes training a machine learning model with data associated with one or more customers of an infrastructure service provider (step 302); receiving one or more job requests from the one or more customers (step 304); identifying one or more insufficiencies in the one or more job requests based on the training (step 306); and performing one or more actions based on the identifying (step 308).

The process 300 can further include wherein the one or more actions include any of automatically remedying the insufficiencies and notifying the one or more customers of the insufficiencies. Responsive to receiving a plurality of job requests, the steps can further include grouping the plurality of job requests based on the training. The steps can further include opening one or more jobs in an Enterprise Resource Planning (ERP) system associated with the infrastructure service provider based on the one or more job requests. The steps can further include providing a link associated with each of the one or more job requests to a web storage system, wherein the link is adapted to allow uploading of job data associated with each of the one or more job requests. The steps can further include closing one or more jobs based on the job data uploaded to the web storage system. The training can include any of supervised and unsupervised learning.

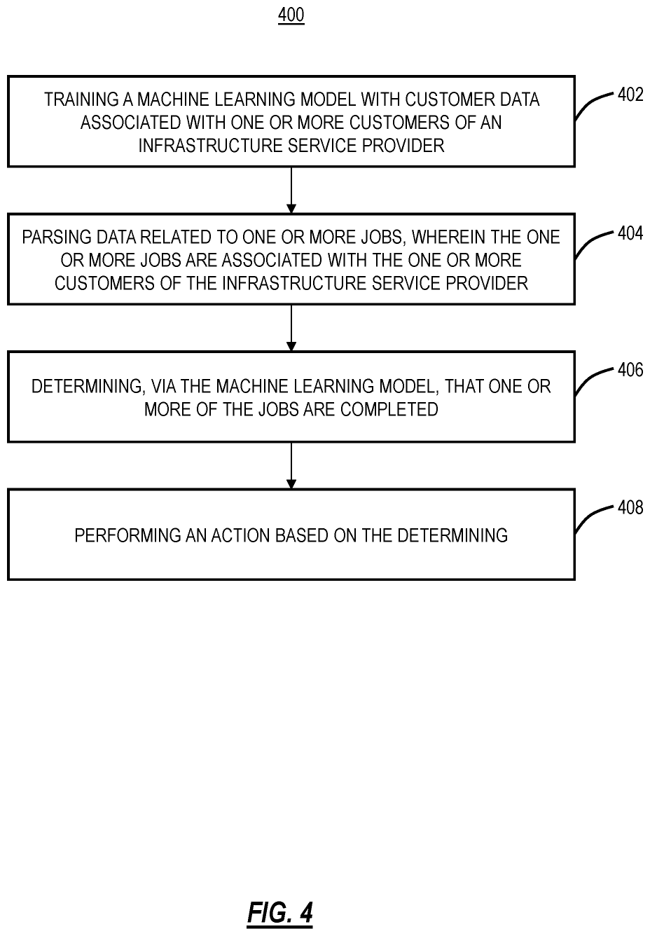

FIG. 4 is a flowchart of a process 400 for managing completed customer infrastructure jobs. The process 400 includes training a machine learning model with customer data associated with one or more customers of an infrastructure service provider (step 402); parsing data related to one or more jobs, wherein the one or more jobs are associated with the one or more customers of the infrastructure service provider (step 404); determining, via the machine learning model, that one or more of the jobs are completed (step 406); and performing an action based on the determining (step 408).

The process 400 can further include any of automatically sending an invoice to a customer and notifying an invoicing team. The data can include one or more files, wherein the machine learning model is adapted to identify files related to the completion of a job. The action can include sending an invoice for jobs determined to be completed, wherein the steps further include sending a follow up notification. Sending the follow up notification can be configured to occur at a particular time, wherein the machine learning model is adapted to determine a particular time based on historical payment behaviors of the one or more customers. The steps can further include grouping invoices associated with a specific customer and sending a follow up notification for the group of invoices at a particular time. The training can include any of supervised and unsupervised learning. The customer data can include historical customer data. The steps can further include generating a closeout package for jobs determined to be completed.

### CONCLUSION

It will be appreciated that some embodiments described herein may include or utilize one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field-Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured to,” “logic configured to,” etc. perform a set of operations, steps, methods, processes, algorithms, functions, techniques, etc. on digital and/or analog signals as described herein for the various embodiments.

Moreover, some embodiments may include a non-transitory computer-readable medium having instructions stored thereon for programming a computer, server, appliance, device, processor, circuit, etc. to perform functions as described and claimed herein. Examples of such non-transitory computer-readable medium include, but are not limited to, a hard disk, an optical storage device, a magnetic storage device, a Read-Only Memory (ROM), a Programmable ROM (PROM), an Erasable PROM (EPROM), an Electrically EPROM (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A non-transitory computer-readable medium comprising instructions that, when executed, cause one or more processors to perform steps of:
training a machine learning model with customer data associated with one or more customers of an infrastructure service provider;
parsing data related to one or more jobs, wherein the one or more jobs are associated with the one or more customers of the infrastructure service provider;
determining, via the machine learning model, that one or more of the jobs are completed; and
performing an action based on the determining.

2. The non-transitory computer-readable medium of claim 1, wherein the one or more actions include any of automatically sending an invoice to a customer and notifying an invoicing team.

3. The non-transitory computer-readable medium of claim 1, wherein the data includes one or more files, and wherein the machine learning model is adapted to identify files related to the completion of a job.

4. The non-transitory computer-readable medium of claim 1, wherein the action includes sending an invoice for jobs determined to be completed, and wherein the steps further comprise:
sending a follow up notification.

5. The non-transitory computer-readable medium of claim 4, wherein sending the follow up notification is configured to occur at a particular time, and wherein the machine learning model is adapted to determine a particular time based on historical payment behaviors of the one or more customers.

6. The non-transitory computer-readable medium of claim 5, wherein the steps comprise grouping invoices associated with a specific customer and sending a follow up notification for the group of invoices at a particular time.

7. The non-transitory computer-readable medium of claim 1, wherein the training includes any of supervised and unsupervised learning.

8. The non-transitory computer-readable medium of claim 1, wherein the customer data includes historical customer data.

9. The non-transitory computer-readable medium of claim 1, wherein the steps further comprise:
generating a closeout package for jobs determined to be completed.

10. A method comprising steps of:
training a machine learning model with customer data associated with one or more customers of an infrastructure service provider;
parsing data related to one or more jobs, wherein the one or more jobs are associated with the one or more customers of the infrastructure service provider;
determining, via the machine learning model, that one or more of the jobs are completed; and
performing an action based on the determining.

11. The method of claim 10, wherein the one or more actions include any of automatically sending an invoice to a customer and notifying an invoicing team.

12. The method of claim 10, wherein the data includes one or more files, and wherein the machine learning model is adapted to identify files related to the completion of a job.

13. The method of claim 10, wherein the action includes sending an invoice for jobs determined to be completed, and wherein the steps further comprise:
sending a follow up notification.

14. The method of claim 13, wherein sending the follow up notification is configured to occur at a particular time, and wherein the machine learning model is adapted to determine a particular time based on historical payment behaviors of the one or more customers.

15. The method of claim 14, wherein the steps comprise grouping invoices associated with a specific customer and sending a follow up notification for the group of invoices at a particular time.

16. The method of claim 10, wherein the training includes any of supervised and unsupervised learning.

17. The method of claim 10, wherein the customer data includes historical customer data.

18. The method of claim 10, wherein the steps further comprise:
generating a closeout package for jobs determined to be completed.
